(19) United States
(12) Patent Application Publication
(10) Pub. No.: US 2007/0032106 A1
(43) Pub. Date: Feb. 8, 2007

(54) Utility connection station

(75) Inventors: Kristine E. Lichtscheidl, St. Francis, MN (US); Mark A. Schaffner, Maple Grove, MN (US); Thomas E. Kramer, Coon Rapids, MN (US); Fusu Thao, St. Paul, MN (US)

Correspondence Address: FOLEY & LARDNER LLP, 777 EAST WISCONSIN AVENUE, MILWAUKEE, WI, 53202-5306, US

(73) Assignee: Fiskars Brands, Inc.

(21) Appl. No.: 11/199,398

(22) Filed: Aug. 8, 2005

(51) Int. Cl. H01R 13/44

(52) U.S. Cl. 439/131

(57) ABSTRACT

A utility connection station includes a housing having movable segments and a plurality of receptacles. At least one extender member slidably engages a passage within the segments and a plurality of supplemental receptacles are coupled to the extender member. The segments are movable between a first position to substantially conceal the extender member within the segments and a second position to expose the extender member to provide access to the supplemental receptacles.

### FIELD

The present invention relates to a utility connection station. The present invention more specifically relates to a utility connection station capable of expansion to provide increased connection capability for utilities. The present invention more specifically relates to an expandable connection station having handles configured to manage utility lines, cables or cords.

### BACKGROUND

It is well known to provide a connection device for utilities (such as power strips, power adapters, etc.). Such known connection devices typically have an incoming supply line (e.g. cord, cable, conductor, etc.) for utilities (such as electrical power, telecommunication signals, data signals, etc.) and one or more receptacles (e.g. outlets, jacks, connectors, etc.) for connecting other utility lines (e.g. electrical power cords, telecommunication lines, coaxial signal conductors, etc.) for distributing utilities from the connection device to other devices or locations.

The known connection devices for utilities typically have a box-like housing provided with receptacles and a power supply cord extending from an end of the housing. The box-like housing may also include an extendable strip of outlets telescopingly mounted for extension from a side of the housing. However, such known connection devices typically do not include an “expandable” body having separable segments or portions that are movable between a retracted (closed) position that conceals a supplemental group of receptacles, and an expanded (open) position that exposes any one or more of the supplemental group of receptacles to accommodate the utility connection needs of a particular user or application. Also, such known connection devices typically are not selectively configurable for use in different positions or applications. Further, such known connection devices typically do not include movable handles that guide, manage and/or route utility lines (e.g. cords, cables, etc.) extending from the receptacles in a convenient and organized manner.

Therefore, it would be desirable to provide a utility connection station having receptacles for interconnecting a plurality of utility lines. It would also be desirable to provide a utility connection station that is configurable for use in multiple positions or orientations. It would also be desirable to provide a utility connection station having a housing that is expandable. It would be further desirable to provide an expandable utility connection station that is deployable from a retracted position to an expanded position to provide access to supplemental receptacles. It would be further desirable to provide an expandable utility connection station having handles for use in expanding and retracting the housing. It would be further desirable to provide a utility connection station having handles with “finger grooves” that serve as a line/cord/cable management device for use in routing, guiding or holding utility lines connected to the receptacles. It would be further desirable to provide a utility connection station having handles capable of supporting the housing in a wall-mount orientation. It would be further desirable to provide a utility connection station having a housing with a contoured hand-grip area to facilitate expansion and retraction of the housing by a user.

Accordingly, it would be desirable to provide a utility connection station having any one or more of these or other advantageous features.

### SUMMARY

The present invention relates to a utility connection station and includes a housing having movable segments and a plurality of receptacles. At least one extender member slidably engages a passage within the segments and a plurality of supplemental receptacles are coupled to the extender member. The segments are movable between a first position to substantially conceal the extender member within the segments and a second position to expose the extender member to provide access to the supplemental receptacles.

The present invention also relates to a connection device for utilities and includes a housing having separable segments and a primary set of receptacles. A cross member slidably engages and interconnects the halves and includes a secondary set of receptacles. The segments are selectively movable between a first position to conceal the secondary set of receptacles and a second position to expose the secondary set of receptacles.

The present invention further relates to a utility connection device and includes a housing having a plurality of receptacles configured to interface with cables for conveying utilities. At least one handle is coupled to the housing for movement between a first position to stow the handle, and a second position configured to permit transport by a user and a third position to guide the cables extending from the receptacles.

The present invention further relates to an adaptor apparatus for use with utilities. The apparatus includes a housing with separable segments and a plurality of receptacles. An extender bar slidably interconnects the segments and at least one cable management device is coupled to the housing to guide cables extending from the receptacles.

### BRIEF DESCRIPTION OF THE DRAWINGS

FIG. 1A is a perspective view of a utility connection station in one position and with handles in one position according to an exemplary embodiment.

FIG. 1B is a perspective view of the utility connection station according to the embodiment of FIG. 1A with handles in another position.

FIG. 2A is a perspective view of a utility connection station in another position and with handles in one position according to an exemplary embodiment.

FIG. 2B is a perspective view of the utility connection station according to the embodiment of FIG. 2A with handles in another position.

FIG. 3A is a front view of the utility connection station of FIG. 2A according to an exemplary embodiment.

FIG. 3B is a front view of the utility connection station of FIG. 1A according to an exemplary embodiment.

### DETAILED DESCRIPTION

Referring to the FIGURES, a utility connection station 10 (e.g. utilities connection device, connection device for utilities, adapter device, connection strip, etc.) is shown according to an exemplary embodiment for use in connecting and protecting various electrical, electronic and communication devices. Utility connection station 10 is shown schematically to include a bifurcated housing or body portion having separable segments (shown for example as two halves) with a plurality of receptacles (e.g. primary receptacles, etc.) provided therein. A slide member (e.g. bridge, cross-member, bar, strip, etc.) having a plurality of supplemental receptacles (e.g. secondary receptacles, etc.) is configured to slidably fit within the two housing halves so that a slide member is concealed within the housing when the halves are retracted to a closed position (e.g. “drawn together”) and the slide member is exposed to provide access to supplemental receptacles between the halves when the housing is expanded to an open position (e.g. “spread apart”). The housing is also shown to include central contoured “grip” areas intended to facilitate gripping by a user for extending and retracting the halves of the housing. The housing is also shown to include handle members pivotally coupled to respective halves. The handles include gripping recesses (e.g. “finger grooves”) to facilitate convenient and ergonomic handling of the connection station by a user, and that also serve as a cord or cable manager (e.g. cable-grooves, guide, retainer, etc.) to guide/route cords/cables connected to any of the receptacles. The handles may also serve as a mounting structure or a hanger for “wall-mounting” the connection station and are also intended to permit a user to extend and retract the halves of the housing.

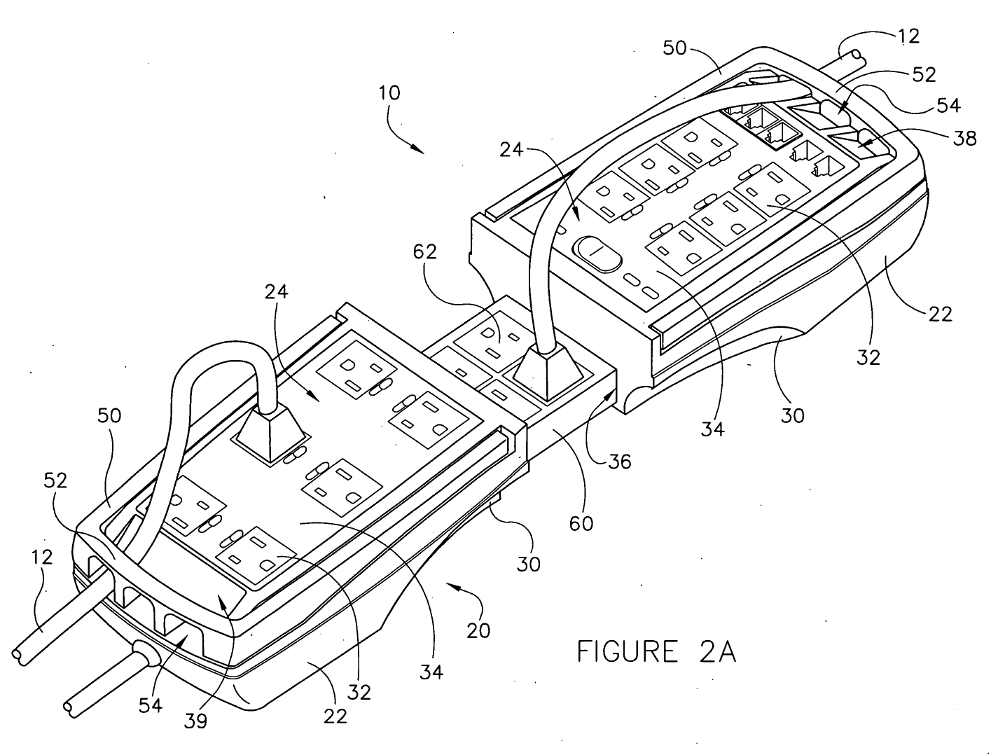

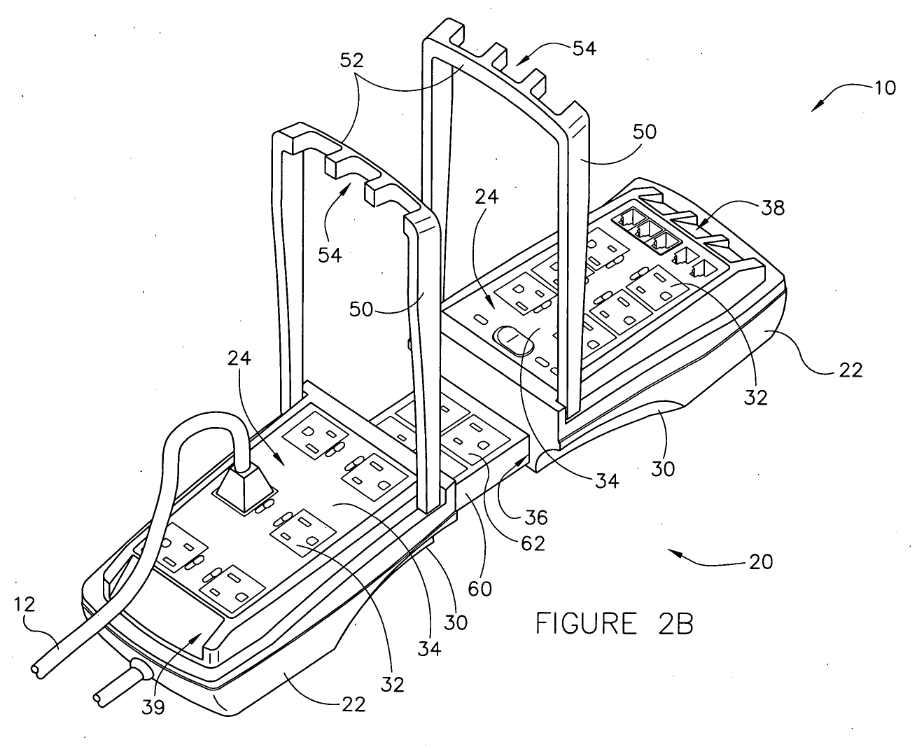

Referring to the FIGURES, utility connection station 10 is shown schematically according to an exemplary embodiment to include a generally elongated housing 20 formed in separable segments 22 (shown for example as two halves) in a streamlined shape with rounded corners, a contoured top 24, a contoured base or bottom 26, and generally curved sides 28 having a concave recess 30 (e.g. “scallops” etc.) to facilitate gripping by a user. According to one embodiment, segments 22 are intended to be “separable” such that the segments may be separated from one another by drawing them apart to an “expanded” state, such as where the segments are physically separated from one another to expose a slide member 60, but the segments remain coupled together by the slide member 60 (see for example FIGS. 2A-2B). According to an alternative embodiment, the segments may be connected by other components, or the segments may be configured to be “separable” in the sense that the segments may be physically uncoupled from one another (e.g. for use in separate applications, locations, within tight space constraints, etc.).

Referring further to the FIGURES, base 26 is intended to permit the housing to be supported in a generally horizontal manner on a work surface (e.g. table, countertop, desk, workbench, etc.) or in a generally vertical manner against a wall, divider, side panel, cabinet, etc.). Housing 20 may be made of any suitable material, such as acrylonitrile butiadene styrene (ABS) plastic formed in a molding operation or other suitable operation, and configured for holding hardware associated with a group of primary receptacles 32. Top 24 of housing 20 may be provided with cover panels 34 (e.g. “faceplates” etc.) made from a material such as polycarbonate and having suitable openings to fit with receptacles on the segments, and may be screen printed with indicia, instructions, warning labels, or other information. Segments 22 are also shown to include recesses proximate the ends of the segments and are intended to permit cords/cables 12 extending from the receptacles to be routed therethrough for managing and guiding such cords/cables. The recesses may be provided as multiple “narrow” recesses (shown schematically as recesses 38 on one segment) or may be provided as a single “wide” recess (shown schematically as recess 39 on another segment) and may be used alone to route or manage cords/cables, or may be used in cooperation with handles to be further described.

According to an alternative embodiment, the housing or body portion may have any suitable shape and contour, and may be made of other materials, such as those having other lightweight and electrical insulating properties. The housing may be formed with any suitable number of separable segments (e.g. three, four, etc.) interconnected by any suitable number of slide members.

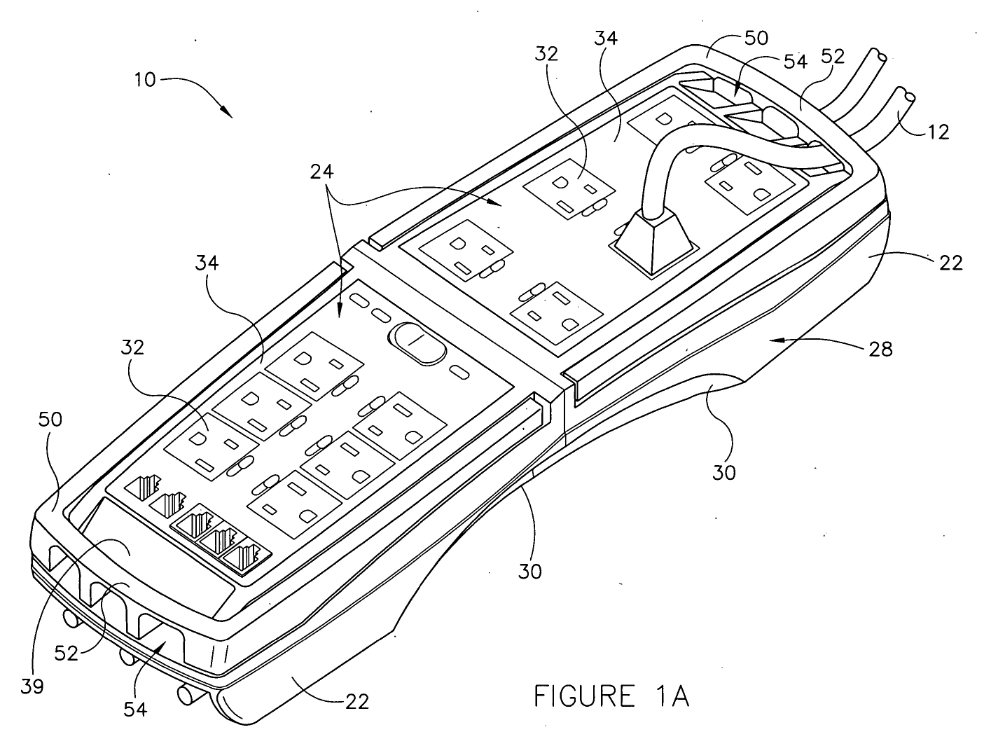

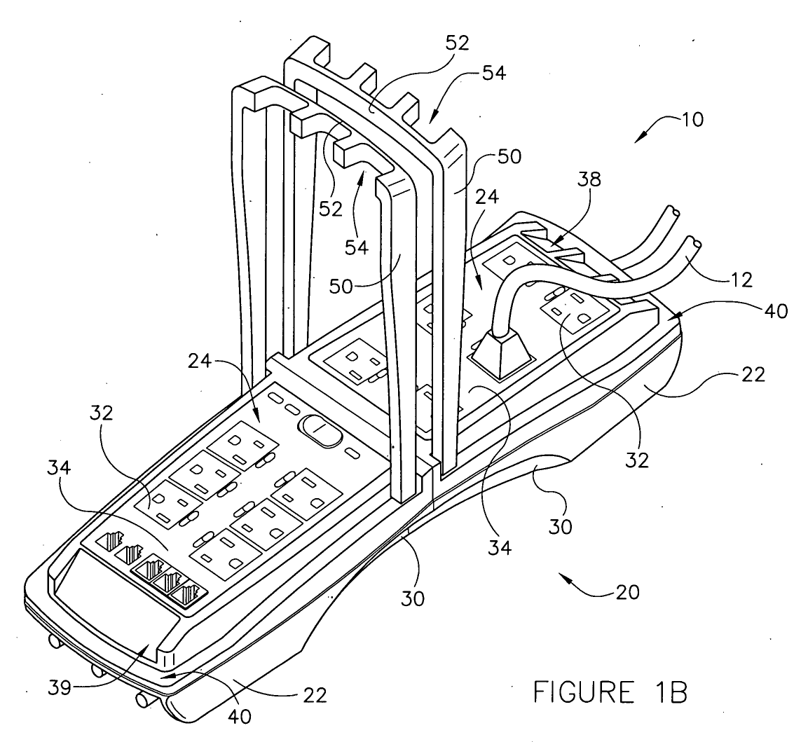

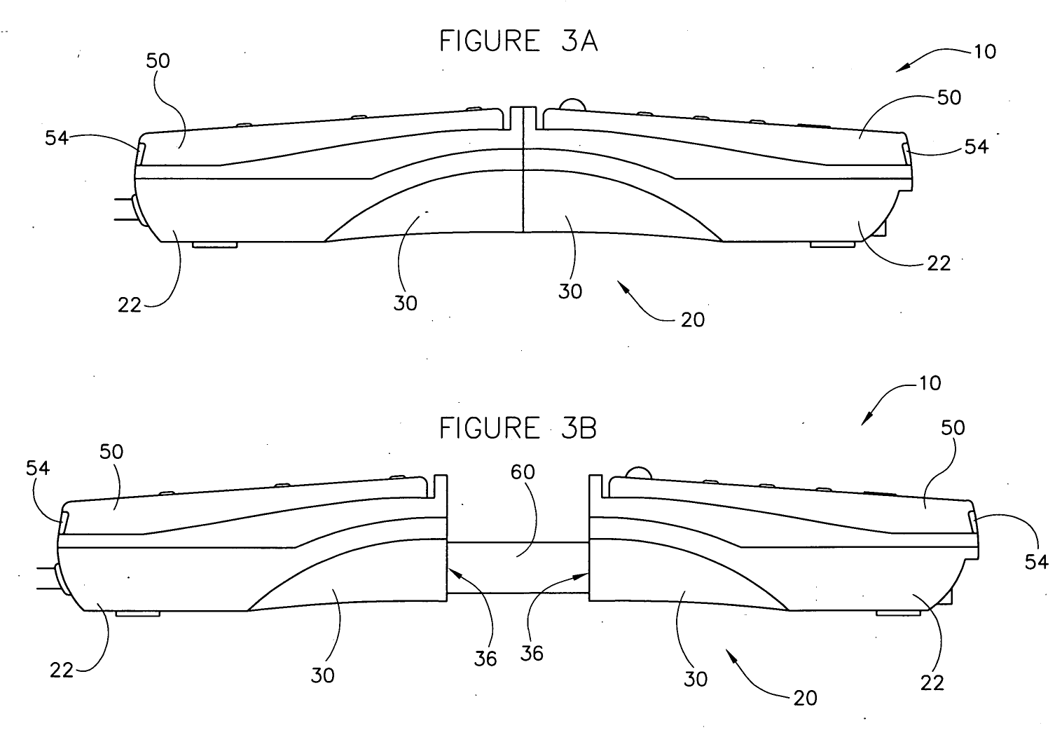

Referring to the FIGURES, segments 22 of housing 20 include a pocket 36 (e.g. passage, opening, etc.) configured to receive a slide member 60 (e.g. cross-member, extender bar, strip, etc.) having a grouping or set of supplemental receptacles 62 formed thereon. Pockets 36 and slide member 60 are shown as a generally rectangular member slidably received within a close-fitting rectangular pocket. According to an alternative embodiment, the slide member and/or the pocket may include suitable engagement structure (e.g. rails, tracks, rib and groove, tab and slot, etc.—not shown) to create a robust and durable sliding interface that permits segments 22 to slide along slide member 60 between a retracted position (see FIGS. 1A, 1B and 3B—to conceal the slide member and supplemental receptacles when not desired) and an expanded position (see FIGS. 2A, 2B and 3A—to expose the slide member and supplemental receptacles when additional utility connection capability is desired). Segments 22 and slide member 60 further include interlocking structure (e.g. travel stops, etc.—not shown) intended to prevent expansion of the segments beyond a fully expanded (e.g. full open) position to prevent separation or disengagement of the segments from the slide member. According to an alternative embodiment, the segments and the slide member may have a detent located adjacent a fully expanded position that permits decoupling at least one segment from the slide member by continuing to expand the segments and overcoming the force created by the detent; so that at least one of the segments may be used at another location, etc.).

The segments and slide member may also include positioners (e.g. projections biased toward engagement with detents, etc.—not shown) that are intended to permit the segments to be temporarily “locked” in a fully expanded (open) position, a fully retracted (closed) position, and any suitable intermediate positions therebetween. Each of the segments may be placed or positioned along slide member in common or different amounts or increments as desired to suit a particular application. For example, the supplemental receptacles on the slide member may be arranged so that electrical outlets are on one end of slide member and communication or data outlets are provided on an opposite end of slide member, so that a user need expand only one segment if only one of supplemental electrical or data outlets are desired. Many other possible combinations of outlets and locations are conceivable and are intended to be within the scope of the disclosure.

According to one embodiment, slide member 60 is made from ABS plastic formed in a molding operation or other suitable operation, and includes an internal passage or channel (not shown) configured to hold and route hardware (e.g. connectors, wires, etc.) associated with supplemental receptacles 62. Segments 22 of housing 20 include suitable internal cavities (not shown) communicating with pockets 36 for routing wiring and other hardware for communicating utilities from a supply source, through segments 22 and into slide member 60 for connection to supplemental receptacles 62 and providing other electronic functions (such as surge protection, voltage regulation, etc.). According to an alternative embodiment, the slide member and the segments may include utility hardware configured to slidably interface (such as sliding contacts engaging conductive strips, etc.—not shown).

Referring further to the FIGURES, connection station 10 is also shown to include a handle member 50 pivotally coupled to each of segments 22 on housing 20. Handle members 50 are movable between a first “stowed” position (see FIGS. 1A, 2A and 3A-3B). In the stowed position, handles 50 are received in a recess 40 (e.g. ledge, etc.) on segments 22 intended to provide a smooth and aesthetically pleasing appearance. The “fit” of handles 50 within recess 40 may be provided with a “slight” interference intended to permit handles 50 to have a “snap-fit” or “press-fit” type engagement with housing 20 and to retain handles 50 in the stowed position until deployed by a user.

Handle members 50 are also pivotally movable to a second “transport” position (see FIGS. 1B and 2B). In the transport position, handles 50 are also shown to have a crossbar portion 52 intended to form a gripping area, which includes a plurality of recesses (shown as “finger grooves” 54) that are intended to enhance the gripping interaction with a hand of a user when the handle is in the second position for transporting the connection station. Handle members 50 are intended to permit a user to easily transport the connection station from one location to another. Handle members 50 are also configured to expand segments 22 (e.g. by pulling outward) and to retract the segments (e.g. by pushing inward). According to one embodiment, the handle members are formed from a translucent material in any one of a variety of colors suitable for matching with trim colors or décor in an intended use environment. Handle members 50 are shown to be pivotally coupled to segments 22, however, according to an alternative embodiment, the handle members may slidable engage the segments of the housing (e.g. in a telescoping manner or the like).

The handle members may also be used as a “cable manager” (see FIGS. 1A and 2A) when moved to the stowed position. In the cable manager position, gripping area 52 with finger grooves 54 is also intended to serve as a cable manager for routing cords 12 (cables, etc.), that are connected to, and extending to/from, receptacles 32 and/or supplemental receptacles 62. Handle members 50 may be biased toward the stowed position (e.g. by a spring member or the like—not shown) to enhance the capability of gripping area 52 to retain cables 12 (e.g. to act as a “clamp” etc.). Handle members 50 may also include a suitable structure (e.g. notch, lip, etc.—not shown) intended to permit wall-mounting of the connection station by “hanging” the handle member on a projection (e.g. hook, peg, etc.—not shown).

Referring to FIGS. 2A and 2B, a plurality of receptacles 32 are provided in segments 22 of housing 20, and a plurality of supplemental receptacles 62 are provided in slide member 60 according to an exemplary embodiment. Receptacles 32 and supplemental receptacles 62 are shown schematically, for example, as electrical receptacles, telecommunication jacks, and coaxial cable connectors of a conventional type, adapted for interconnection with utility lines having suitable connectors of a corresponding conventional type. Receptacles 32 and supplemental receptacles 62 may be configured to provide a supply of a utility (e.g. electrical power, telecommunication signal, voice/data signal, fiber-optic signal, infrared signal, etc.) from a source (shown schematically as electrical power cord and a coaxial signal cable according to one embodiment) in a conventional manner. Certain receptacles may also be configured for adapting (e.g. joining, coupling, splitting, distributing, etc.) utilities that are provided at other receptacles (such an “inlet” receptacle and an “outlet” receptacle, as are generally known in conventional adapters). The receptacles may also be provided with covers (such as sliding covers—not shown) for shielding exposure to the utilities. The receptacles and supplemental receptacles may also be provided with protective features (such as surge protection, etc.), a master on-off switch, and a grounded power cord, as are generally available in conventional utilities adapters.

According to any preferred embodiment, a utility connection station is provided that includes a housing with selectively expandable segments, shown as bifurcated halves, configured for separation to permit access to a concealed set of supplemental receptacles provided on a cross-member. Handles are pivotally coupled to the halves for transporting and mounting the connection station, and for moving the halves of the housing and for managing a plurality of utility lines/cords/cables connected to the receptacles.

According to any alternative embodiment, the utility connection station may have any suitable shape configured for expansion and retraction to selectively expose or conceal a source of supplemental receptacles for adapting the capability of the utility connection station to the needs of a particular work environment or situation. For example, the connection station may have a “ring-shaped” housing (or other geometric shaped housing) that separates into two (or more) segments having internal slide members with receptacles, for interconnecting the segments. Further, the connection stations may be equipped with suitable hardware (e.g. of a conventional type) for receiving, transmitting, adapting, distributing or splitting utilities (such as electrical power, telecommunication signals, voice/data signals, etc.). The utility connection station may also be equipped with suitable protection devices (e.g. of a conventional type such as power surge arrestors, on-off switches, overload protection, ground fault interruption, indicator lights, EMI/RFI filters, “always-on” receptacles that are independent of on-off switches, etc.).

It is important to note that the construction and arrangement of the elements of the expandable utility connection station as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the line management devices may be reconfigured, actuation-assisted, or otherwise varied, or the length or width of the structures and the location and type of the receptacles or other elements of the utility connection station may be varied. By further way of example, the hinged or pivoting handles may be configured as slidable handles, and the slide member may have any suitable cross sectional shape (e.g. rectangular, circular, half-moon, etc.). It should be noted that the elements and/or assemblies of the utility connection station may be constructed from any of a wide variety of materials that provide sufficient strength, durability and electrical resistance, in any of a wide variety of colors, textures, shapes and combinations. It should also be noted that the utility connection station may be configured in a suitable shape (e.g. rectangular, triangular, oval, etc.) and used in association with a wide variety stand configurations to support use in any of a wide variety of orientations and applications. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the inventions as expressed in the appended claims.

What is claimed is:

1. A utility connection station, comprising:
a housing having movable segments and a plurality of receptacles;
at least one extender member slidably engaging a passage within the segments;
a plurality of supplemental receptacles coupled to the extender member;
the segments being movable between a first position to substantially conceal the extender member within the segments and a second position to expose the extender member to provide access to the supplemental receptacles.

2. The utility connection station of claim 1 wherein the housing comprises bifurcated halves.

3. The utility connection station of claim 1 wherein the housing further comprises a contoured gripping area.

4. The utility connection station of claim 1 further comprising at least one handle coupled to a segment.

5. The utility connection station of claim 4 wherein the handle is movable between a stowed position, a transport position and a cable manager position.

6. The utility connection station of claim 5 wherein the handle comprises recesses configured to receive fingers of a user when the handle is in the transport position and to guide cables when the handle is in the cable manager position.

7. The utility connection station of claim 4 wherein the at least one handle comprises a first handle pivotally coupled to a first segment and a second handle pivotally coupled to a second segment.

8. A connection device for utilities, comprising:
a housing having separable segments and a primary set of receptacles;
a cross member slidably engaging and interconnecting the segments and having a secondary set of receptacles;
the segments selectively movable between a first position to conceal the secondary set of receptacles and a second position to expose the secondary set of receptacles.

9. The connection device for utilities of claim 8 wherein the segments comprise a contoured gripping area.

10. The connection device for utilities of claim 8 further comprising a handle coupled to at least one of the segments.

11. The connection device for utilities of claim 10 wherein the handle is pivotally coupled to at least one of the segments.

12. The connection device for utilities of claim 10 wherein the handle comprises grooves configured to guide cables extending from at least one of the primary set of receptacles and the secondary set of receptacles.

13. The connection device for utilities of claim 8 wherein the utilities are at least one of electrical power, telecommunication signals, voice signals and data signals.

14. A utility connection device, comprising:
a housing having a plurality of receptacles configured to interface with cables for conveying utilities; and
at least one handle coupled to the housing and movable between a first position to stow the handle, and a second position configured to permit transport by a user and a third position to guide the cables extending from the receptacles.

15. The utility connection device for utilities of claim 14 wherein the housing comprises at least two separable segments.

16. The utility connection device for utilities of claim 15 further comprising an extender bar having supplemental receptacles and interconnecting the segments.

17. The utility connection device for utilities of claim 16 wherein the extender bar is slidably received in each of the segments in a telescoping manner.

18. The utility connection device for utilities of claim 14 wherein the handle comprises recesses formed therein and configured to guide one or more cables extending from the receptacles.

19. An adaptor apparatus for use with utilities, comprising:
a housing having separable segments and a plurality of receptacles;
an extender bar slidably interconnecting the separable segments; and
at least one cable management device coupled to the housing and configured to guide cables extending from the receptacles.

20. The apparatus of claim 19 wherein the separable segments comprise bifurcated halves.

21. The apparatus of claim 19 wherein the extender bar comprises supplemental receptacles.

22. The apparatus of claim 21 wherein the segments are movable between an expanded position to expose the supplemental receptacles and a retracted position to substantially conceal the supplemental receptacles.

23. The apparatus of claim 19 wherein the cable management device is a handle coupled to at least one of the segments.

24. The apparatus of claim 23 wherein the handle comprises a shape configured to guide cables.
